(19) United States
(12) Patent Application Publication
(10) Pub. No.: US 2025/0081297 A1
(43) Pub. Date: Mar. 6, 2025

(54) APPARATUS FOR HEATING SMOKABLE MATERIAL

(71) Applicant: BRITISH AMERICAN TOBACCO (INVESTMENTS) LIMITED, London (GB)

(72) Inventors: Thomas P. BLANDINO, Cottage Grove, WI (US); Andrew P. WILKE, Madison, WI (US); James J. FRATER, Madison, WI (US); Benjamin J. PAPROCKI, Cottage Grove, WI (US)

(21) Appl. No.: 18/951,253

(22) Filed: Nov. 18, 2024

Related U.S. Application Data
(63) Continuation of application No. 15/754,801, filed on Feb. 23, 2018.
Application No. 15/754,801 is a continuation of application No. 14/840,652, filed on Aug. 31, 2015, now abandoned.

(51) Int. Cl. H05B 6/10; A24D 1/20; A24F 40/20; A24F 40/465; H05B 6/36

(52) U.S. Cl. CPC H05B 6/108; A24D 1/20; A24F 40/465; H05B 6/36; A24F 40/20

(57) ABSTRACT

Disclosed is apparatus for heating smokable material to volatilize at least one component of the smokable material. The apparatus includes a heating zone for receiving at least a portion of an article comprising smokable material, a magnetic field generator for generating a varying magnetic field, and an elongate heating element projecting into the heating zone. The heating element includes heating material that is heatable by penetration with the varying magnetic field to heat the heating zone.

### PRIORITY CLAIM

The present application is a continuation application of U.S. patent application Ser. No. 15/754,801 filed Feb. 23, 2018, which is a National Phase entry of PCT Application No. PCT/EP2016/070176, filed Aug. 26, 2016, which claims priority from U.S. patent application Ser. No. 14/840,652, filed Aug. 31, 2015, each of which is hereby fully incorporated herein by reference.

### TECHNICAL FIELD

The present disclosure relates to apparatus for heating smokable material to volatilize at least one component of the smokable material, to articles for use with such apparatus, and to systems comprising such articles and apparatuses.

### BACKGROUND

Smoking articles such as cigarettes, cigars and the like burn tobacco during use to create tobacco smoke. Attempts have been made to provide alternatives to these articles by creating products that release compounds without combusting. Examples of such products are so-called “heat not burn” products or tobacco heating devices or products, which release compounds by heating, but not burning, material. The material may be, for example, tobacco or other non-tobacco products, which may or may not contain nicotine.

### SUMMARY

A first aspect of the present disclosure provides apparatus for heating smokable material to volatilize at least one component of the smokable material, the apparatus comprising: a heater zone or heating zone for receiving at least a portion of an article comprising smokable material; a magnetic field generator for generating a varying magnetic field; and an elongate heater or heating element projecting into the heating zone; wherein the heating element comprises heating material that is heatable by penetration with the varying magnetic field to heat the heating zone.

In an exemplary embodiment, the apparatus comprises a body defining the heating zone, wherein the body is free of heating material that is heatable by penetration with the varying magnetic field.

In an exemplary embodiment, the heating zone is elongate, and the heating element extends along a longitudinal axis that is substantially coincident with a longitudinal axis of the heating zone.

In an exemplary embodiment, the heating element has a length and a cross-section perpendicular to the length, the cross-section has a width and a depth, the length is greater than the width, and the width is greater than the depth.

In an exemplary embodiment, the heating element is planar, or substantially planar.

In an exemplary embodiment, the apparatus comprises an opening at a first end of the heating zone through which the portion of the article is insertable into the heating zone; and the heating element projects into the heating zone from a second end of the heating zone opposite the first end, and the heating element has a free end distal from the second end of the heating zone that is arranged relative to the opening so as to enter the article as the article is inserted into the heating zone.

In an exemplary embodiment, the free end of the heating element is tapered.

In an exemplary embodiment, an inner surface of the body has a thermal emissivity of 0.1 or less. In an exemplary embodiment, the thermal emissivity is 0.05 or less.

In an exemplary embodiment, an outer surface of the body has a thermal emissivity of 0.1 or less. In an exemplary embodiment, the thermal emissivity is 0.05 or less.

In an exemplary embodiment, the magnetic field generator comprises a coil and a device for passing a varying electrical current through the coil.

In an exemplary embodiment, the coil encircles the body.

In an exemplary embodiment, the coil encircles the heating zone.

In an exemplary embodiment, the coil encircles the heating element.

In an exemplary embodiment, the coil extends along a longitudinal axis that is substantially coincident with a longitudinal axis of the heating element.

In an exemplary embodiment, an impedance of the coil is equal, or substantially equal, to an impedance of the heating element.

In an exemplary embodiment, the heating material comprises one or more materials selected from the group consisting of: an electrically-conductive material, a magnetic material, and a non-magnetic material.

In an exemplary embodiment, the heating material comprises a metal or a metal alloy.

In an exemplary embodiment, the heating material comprises one or more materials selected from the group consisting of: aluminum, gold, iron, nickel, cobalt, conductive carbon, graphite, plain-carbon steel, stainless steel, ferritic stainless steel, copper, and bronze.

In an exemplary embodiment, the heating material is susceptible to eddy currents being induced in the heating material when penetrated by the varying magnetic field.

In an exemplary embodiment, the heating element is arranged to change shape when heated.

In an exemplary embodiment, the heating element comprises two portions that are attached to each other and have respective different coefficients of expansion.

In an exemplary embodiment, the heating element comprises a bimetallic strip.

In an exemplary embodiment, the heating material is exposed to the heating zone.

In an exemplary embodiment, the body is made from non-magnetic and non- electrically-conductive material.

In an exemplary embodiment, the apparatus comprises a first mass of thermal insulation between the coil and the body.

In respective exemplary embodiments, the first mass of thermal insulation may comprise, for example, one or more thermal insulators selected from the group consisting of: a closed-cell material, a closed-cell plastics material, an aerogel, vacuum insulation, silicone foam, and a rubber material.

In an exemplary embodiment, the apparatus comprises a second mass of thermal insulation between that encircles the coil.

In respective exemplary embodiments, the second mass of thermal insulation may comprise, for example, one or more materials selected from the group consisting of: aerogel, vacuum insulation, wadding, fleece, non-woven material, non-woven fleece, woven material, knitted material, nylon, foam, polystyrene, polyester, polyester filament, polypropylene, a blend of polyester and polypropylene, cellulose acetate, paper or card, and corrugated material such as corrugated paper or card.

In an exemplary embodiment, the heating element comprises a heating member that consists entirely, or substantially entirely, of the heating material.

In an exemplary embodiment, the heating element consists entirely, or substantially entirely, of the heating material.

In an exemplary embodiment, a first portion of the heating element is more susceptible to eddy currents being induced therein by penetration with the varying magnetic field than a second portion of the heating element.

In an exemplary embodiment, the apparatus comprises a catalytic material on at least a portion of an outer surface of the heating element.

In an exemplary embodiment, the body comprises a member and a coating on an inner surface of the member that is smoother or harder than the inner surface of the member.

In an exemplary embodiment, the magnetic field generator is for generating a plurality of varying magnetic fields for penetrating different respective portions of the heating element.

In an exemplary embodiment, the apparatus comprises a temperature sensor for sensing a temperature of the heating zone or of the heating element. In an exemplary embodiment, the magnetic field generator is arranged to operate on the basis of an output of the temperature sensor.

A second aspect of the present disclosure provides apparatus for heating smokable material to volatilize at least one component of the smokable material, the apparatus comprising: first and second members; a heating zone between the first and second members for receiving at least a portion of an article comprising smokable material; and a magnetic field generator for generating a varying magnetic field to be used in heating the heating zone; wherein the first and second members are movable towards each other to compress the heating zone.

In an exemplary embodiment, the magnetic field generator is for generating a varying magnetic field that penetrates the heating zone.

In an exemplary embodiment, the apparatus comprises a heating element comprising heating material that is heatable by penetration with the varying magnetic field to heat the heating zone.

In an exemplary embodiment, the first and second members comprise heating material that is heatable by penetration with the varying magnetic field to heat the heating zone.

A third aspect of the present disclosure provides an article for use with apparatus for heating smokable material to volatilize at least one component of the smokable material, the article comprising: a mass of smokable material; and a wiper connected to the mass of smokable material; wherein a heating element for heating the smokable material is insertable into the mass of smokable material while making contact with the wiper.

In respective exemplary embodiments, the wiper comprises one or more of: a scraper, a blade, an abrasive pad, a foam material, metal filaments, metal filaments of plural relative orientations, tangled metal filaments, and metal bristles.

In an exemplary embodiment, the mass of smokable material is elongate, and the wiper is located at a longitudinal end of the mass of smokable material.

In an exemplary embodiment, the article has a cavity formed therein for receiving the heating element in use.

In an exemplary embodiment, the wiper defines at least a portion of the cavity.

In an exemplary embodiment, the wiper defines a mouth of the cavity.

A fourth aspect of the present disclosure provides a system, comprising: apparatus for heating smokable material to volatilize at least one component of the smokable material, the apparatus comprising a heating zone for receiving at least a portion of an article comprising smokable material, a magnetic field generator for generating a varying magnetic field, and an elongate heating element projecting into the heating zone, wherein the heating element comprises heating material that is heatable by penetration with the varying magnetic field to heat the heating zone; and the article for use with the apparatus, the article comprising the smokable material.

In an exemplary embodiment, the article comprises a mass of smokable material, and a wiper connected to the mass of smokable material, wherein the heating element is insertable into the mass of smokable material while making contact with the wiper.

In respective exemplary embodiments, the article of the system may have any of the features of the above-described exemplary embodiments of the article of the third aspect of the present disclosure.

In respective exemplary embodiments, the apparatus of the system may have any of the features of the above-described exemplary embodiments of the apparatus of the first aspect of the present disclosure or of the second aspect of the present disclosure.

### BRIEF DESCRIPTION OF THE DRAWINGS

Embodiments of the disclosure will now be described, by way of example only, with reference to the accompanying drawings, in which:

FIG. 1 shows a schematic perspective view of a portion of an example of apparatus for heating smokable material to volatilize at least one component of the smokable material.

FIG. 2 shows a schematic cross-sectional view of the apparatus of which only the portion is shown in FIG. 1.

FIG. 3 shows a schematic cross-sectional view of an article for use with the apparatus of FIGS. 1 and 2.

FIG. 4a shows a schematic cross-sectional view of a portion of an example of another apparatus for heating smokable material to volatilize at least one component of the smokable material, in which first and second members of the apparatus are spaced apart by a first distance.

FIG. 4b shows a schematic cross-sectional view of the portion of the apparatus shown in FIG. 4a, in which the first and second members of the apparatus are spaced apart by a second distance that is less than the first distance.

FIG. 5a shows a schematic cross-sectional view of a portion of an example of another apparatus for heating smokable material to volatilize at least one component of the smokable material, in which first and second members of the apparatus are spaced apart by a first distance.

FIG. 5b shows a schematic cross-sectional view of the portion of the apparatus shown in FIG. 5a, in which the first and second members of the apparatus are spaced apart by a second distance that is less than the first distance.

### DETAILED DESCRIPTION

As used herein, the term “smokable material” includes materials that provide volatilized components upon heating, typically in the form of vapor or an aerosol. “Smokable material” may be a non-tobacco-containing material or a tobacco-containing material. “Smokable material” may, for example, include one or more of tobacco per se, tobacco derivatives, expanded tobacco, reconstituted tobacco, tobacco extract, homongenized tobacco or tobacco substitutes. The smokable material can be in the form of ground tobacco, cut rag tobacco, extruded tobacco, liquid, gel, gelled sheet, powder, or agglomerates. “Smokable material” also may include other, non-tobacco, products, which, depending on the product, may or may not contain nicotine. “Smokable material” may comprise one or more humectants, such as glycerol or propylene glycol.

As used herein, the term “heating material” or “heater material” refers to material that is heatable by penetration with a varying magnetic field.

As used herein, the terms “flavor” and “flavorant” refer to materials which, where local regulations permit, may be used to create a desired taste or aroma in a product for adult consumers. They may include extracts (e.g., licorice, hydrangea, Japanese white bark magnolia leaf, chamomile, fenugreek, clove, menthol, Japanese mint, aniseed, cinnamon, herb, wintergreen, cherry, berry, peach, apple, Drambuie, bourbon, scotch, whiskey, spearmint, peppermint, lavender, cardamom, celery, cascarilla, nutmeg, sandalwood, bergamot, geranium, honey essence, rose oil, vanilla, lemon oil, orange oil, cassia, caraway, cognac, jasmine, ylang-ylang, sage, fennel, piment, ginger, anise, coriander, coffee, or a mint oil from any species of the genus Mentha), flavor enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, oil, liquid, gel, powder, or the like.

Induction heating is a process in which an electrically-conductive object is heated by penetrating the object with a varying magnetic field. The process is described by Faraday's law of induction and Ohm's law. An induction heater may comprise an electromagnet and a device for passing a varying electrical current, such as an alternating current, through the electromagnet. When the electromagnet and the object to be heated are suitably relatively positioned so that the resultant varying magnetic field produced by the electromagnet penetrates the object, one or more eddy currents are generated inside the object. The object has a resistance to the flow of electrical currents. Therefore, when such eddy currents are generated in the object, their flow against the electrical resistance of the object causes the object to be heated. This process is called Joule, ohmic, or resistive heating. An object that is capable of being inductively heated is known as a susceptor.

It has been found that, when the susceptor is in the form of a closed circuit, magnetic coupling between the susceptor and the electromagnet in use is enhanced, which results in greater or improved Joule heating.

Magnetic hysteresis heating is a process in which an object made of magnetic material is heated by penetrating the object with a varying magnetic field. A magnetic material can be considered to comprise many atomic-scale magnets, or magnetic dipoles. When a magnetic field penetrates such material, the magnetic dipoles align with the magnetic field. Therefore, when a varying magnetic field, such as an alternating magnetic field, for example as produced by an electromagnet, penetrates the magnetic material, the orientation of the magnetic dipoles changes with the varying applied magnetic field. Such magnetic dipole reorientation causes heat to be generated in the magnetic material.

When an object is both electrically-conductive and magnetic, penetrating the object with a varying magnetic field can cause both Joule heating and magnetic hysteresis heating in the object. Moreover, the use of magnetic material can strengthen the magnetic field, which can intensify the Joule heating.

In each of the above processes, as heat is generated inside the object itself, rather than by an external heat source by heat conduction, a rapid temperature rise in the object and more uniform heat distribution can be achieved, particularly through selection of suitable object material and geometry, and suitable varying magnetic field magnitude and orientation relative to the object. Moreover, as induction heating and magnetic hysteresis heating do not require a physical connection to be provided between the source of the varying magnetic field and the object, design freedom and control over the heating profile may be greater, and cost may be lower.

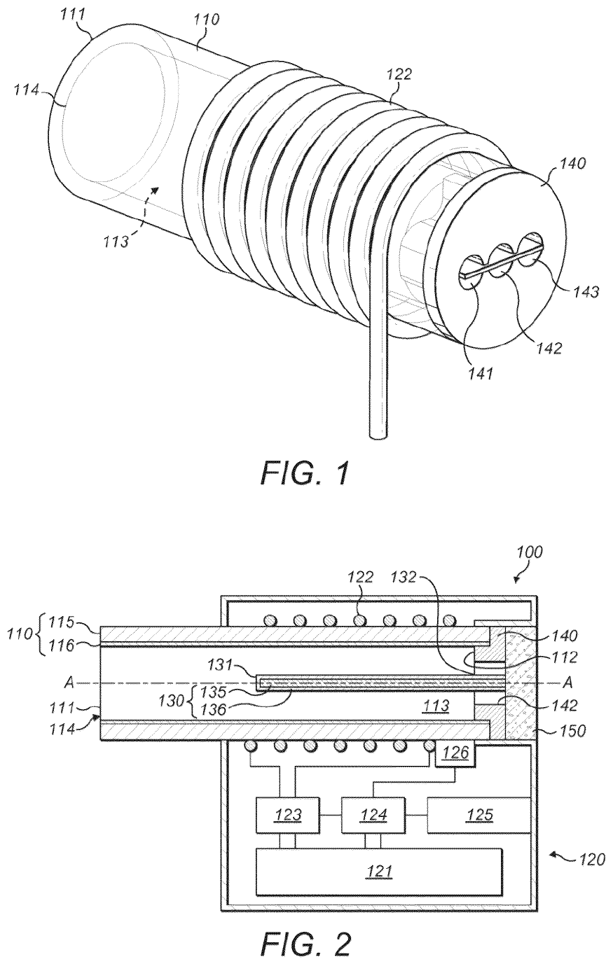

Referring to FIGS. 2 and 1 there are respectively shown a schematic cross-sectional view of an example of apparatus for heating smokable material to volatilized at least one component of the smokable material, according to an embodiment of the disclosure, and a schematic perspective view of a portion of the apparatus. Broadly speaking, the apparatus 100 comprises a heating zone 113 for receiving at least a portion of an article comprising smokable material, a magnetic field generator 120 for generating a varying magnetic field, and an elongate heating element 130 projecting into the heating zone 113. In this embodiment, the heating zone 113 comprises a cavity. The heating element 130 comprises heating material that is heatable by penetration with the varying magnetic field to heat the heating zone 113.

In this embodiment, the apparatus 100 comprises a body 110 that defines the heating zone 113, and that is free of heating material that is heatable by penetration with the varying magnetic field. However, in other embodiments, the body 110 may comprise heating material that is heatable by penetration with the varying magnetic field, or may be omitted.

In this embodiment, the body 110 is a tubular body 110 that encircles the heating zone 113. However, in other embodiments, the body 110 may not be fully tubular. For example, in some embodiments, the body 110 may be tubular save for one or more axially-extending gaps or slits formed in the body 110. As noted above, in this embodiment, the body 110 itself is free of any heating material that is heatable by penetration with a varying magnetic field. Thus, when a varying magnetic field is generated by the magnetic field generator 120 as discussed below, more energy of the varying magnetic field is available to cause heating of the heating element 130. The body 110 may be made of glass, a ceramics material, or a high-temperature-tolerant plastics material, such as polyether ether ketone (PEEK) or polyetherimide (PEI), an example of which is Ultem.

In this embodiment, the body 110 has a substantially circular cross section. However, in other embodiments, the body 110 may have a cross section other than circular, such as square, rectangular, polygonal or elliptical. In this embodiment, the heating zone 113 is defined by the body 110. That is, the body 110 delineates or delimits the heating zone 113. In this embodiment, the heating zone 113 also has a substantially circular cross section. However, in other embodiments, the heating zone 113 may have a cross section other than circular, such as square, rectangular, polygonal or elliptical.

In this embodiment, the body 110 comprises a tubular member 115 extending around the heating zone 113, and a coating 116 on an inner surface of the member 115. The coating 115 is smoother or harder than the inner surface of the member 115 itself. Such a smoother or harder coating 116 may facilitate cleaning of the body 110 after use of the apparatus 100. The coating 116 could be made of glass or a ceramic material, for example. In other embodiments, the coating 116 may be omitted.

In some embodiments, an inner surface or an outer surface of the body 110 may have a thermal emissivity of 0.1 or less. For example, in some embodiments, the thermal emissivity may be 0.05 or less, such as 0.03 or 0.02. Such low emissivity may help to retain heat in the heating zone 113, may help to prevent heat loss from the heating element 130 to components of the apparatus 100 other than the heating zone 113, may help to increase heating efficiency of the heating zone 113, and/or may help to reduce the transfer of heating energy from the heating element 130 to an outer surface of the apparatus 100. This may improve the comfortableness with which a user is able to hold the apparatus 100. The thermal emissivity may be achieved by making the inner surface or outer surface of the body 110 from a low emissivity material, such as silver or aluminum.

The heating zone 113 of this embodiment has a first end 111 and an opposite second end 112, and the body 110 defines an opening 114 at the first end 111 through which the article, or the portion thereof, is insertable into the heating zone 113. In some embodiments, the opening 114 may be closable or blockable, such as by a mouthpiece of the apparatus 100, e.g. the mouthpiece discussed below. In this embodiment, the heating zone 113 is elongate with a length from the first end 111 to the second end 112, and the heating element 130 extends along a longitudinal axis that is substantially coincident with a longitudinal axis A-A of the heating zone 113. In other embodiments, the longitudinal axes A-A of the heating zone 113 and the heating element 130 may be aligned with each other by being parallel to each other, or may be oblique to each other.

In some embodiments, one end of the heating zone 113 is closed. This may help the heating zone 113 act as a receptacle for smokable material, or act as a support during pushing of the heating element 130 into a mass of smokable material.

In this embodiment, the heating element 130 projects into the heating zone 113 from the second end 112 of the heating zone 113. More specifically, in this embodiment, an end member 140 is provided at an end portion of the body 110 remote from the opening 114. In this embodiment, the end member 140 comprises a plug that is attached to the end portion of the body 110, such as by friction or an adhesive. However, in other embodiments the end member 140 may take a different form or be integral with the body 110. In this embodiment, the end member 140 defines the second end 112 of the heating zone 113. Moreover, in this embodiment, the heating element 130 is attached to the end member 140 and extends from the end member 140 into the heating zone 113. In this embodiment, a section of the heating element 130 is located in the end member 140, which may help to increase the robustness of a connection between the heating element 130 and the end member 140. In some other embodiments, the heating element 130 may instead abut and extend from a face of the end member 140 that faces the heating zone 113.

In this embodiment, a thermal insulator 150 is provided on an outer side of the end member 140. The thermal insulator 150 may help to prevent heat loss from the heating element 130 out of the apparatus 100, may help to increase heating efficiency of the heating zone 113, and/or may help to reduce the transfer of heating energy from the heating element 130 to an outer surface of the apparatus 100. This may improve the comfortableness with which a user is able to hold the apparatus 100.

In some embodiments, the thermal insulator 150 may comprise any one or more of the materials discussed below for first and/or second masses of thermal insulation. In this embodiment, the thermal insulator 150 is air permeable. In this embodiment, a plurality of air inlets 141, 142, 143 extend through the end member 140. The air inlets 141, 142, 143 place the heating zone 113 in fluid communication with the air permeable thermal insulator 150. Thus, in use of the apparatus 100, air may be drawn into the heating zone 113 from an exterior of the apparatus 100 via the air permeable thermal insulator 150 and the air inlets 141, 142, 143. In other embodiments, only one air inlet, or no air inlets, may extend through the end member 140. In such other embodiments, air may be drawn into the heating zone 113 from an exterior of the apparatus 100 via a different route, such as via an air inlet through the body 110 or in a mouthpiece (not shown) of the apparatus 100.

In this embodiment, the heating element 130 has a free first end 131 distal from the second end 112 of the heating zone 113 that is arranged relative to the opening 114 so as to enter the article as the article is inserted into the heating zone 113 via the opening 114. In some embodiments, the free end 131 of the heating element 130 may be tapered, for example, to facilitate such entry into the article.

The heating element 130 of this embodiment has a length within the heating zone 113 from the first end 131 to a point 132 on the heating element 130 at the second end 112 of the heating zone 113. The heating element 130 also has a cross-section perpendicular to its length. The cross-section has a width and a depth, the length is greater than the width, and the width is greater than the depth. Therefore, the depth or thickness of the heating element 130 is relatively small as compared to the other dimensions of the heating element 130. A susceptor may have a skin depth, which is an exterior zone within which most of an induced electrical current occurs. By providing that the heating element 130 has a relatively small thickness, a greater proportion of the heating element 130 may be heatable by a given varying magnetic field, as compared to a heating element 130 having a depth or thickness that is relatively large as compared to the other dimensions of the heating element 130. Thus, a more efficient use of material is achieved. In turn, costs are reduced. However, in other embodiments, the heating element 130 may have a cross-section that is a shape other than rectangular, such as circular, elliptical, annular, star-shaped, polygonal, square, or triangular. In this embodiment, the cross section of the heating element 130 is constant along the length of the heating element 130. Moreover, in this embodiment, the heating element 130 is planar, or substantially planar. The heating element 130 of this embodiment can be considered a flat strip. However, in other embodiments, this may not be the case.

The heating element 130 of this embodiment comprises a heating member 135 consisting entirely, or substantially entirely, of the heating material. The heating member 135 thus is heatable by penetration with a varying magnetic field. Moreover, in this embodiment, the heating element 130 comprises a coating 136 on an outer surface of the heating member 135. The coating 136 is smoother or harder than the outer surface of the heating member 135 itself. Such a smoother or harder coating 136 may facilitate cleaning of the heating element 130 after use of the apparatus 100. The coating 136 could be made of glass or a ceramic material, for example. In other embodiments, the coating 136 may be provided on only a portion of the heating member 135 or be omitted. In some embodiments, the coating may be rougher than the outer surface of the heating member 135 itself, so as to increase the surface area over which the heating element 130 is contactable with an article or smokable material inserted in the heating zone 113 in use. In some such other embodiments, the heating material may be exposed to the heating zone 113. Thus, when the heating material is heated, heat may be transferred directly from the heating material to the heating zone 113.

The heating material may comprise one or more materials selected from the group consisting of: an electrically-conductive material, a magnetic material, and a non-magnetic material. The heating material may comprise a metal or a metal alloy. The heating material may comprise one or more materials selected from the group consisting of: aluminum, gold, iron, nickel, cobalt, conductive carbon, graphite, plain-carbon steel, stainless steel, ferritic stainless steel, copper, and bronze. Other heating material(s) may be used in other embodiments. In this embodiment, the heating material of the heating element 130 comprises electrically-conductive material. Thus, the heating material is susceptible to eddy currents being induced in the heating material when penetrated by a varying magnetic field. Therefore, the heating element 130 is able to act as a susceptor when subjected to the changing magnetic field. It has also been found that, when magnetic electrically-conductive material is used as the heating material, magnetic coupling between the heating element 130 and the coil 122 of the magnetic field generator 120, which will be described below, in use may be enhanced. In addition to potentially enabling magnetic hysteresis heating, this can result in greater or improved Joule heating of the heating element 130, and thus greater or improved heating of the heating zone 113.

In some embodiments, the apparatus may comprise a catalytic material on at least a portion of an outer surface of the heating element 130. The catalytic material may be provided on all of the outer surface of the heating element 130, or on only some portion(s) of the outer surface of the heating element 130. The catalytic material may take the form of a coating. The provision of such a catalytic material means that, in use, the apparatus 100 may have a heated, chemically active surface. In use, the catalytic material may act to convert, or increase the rate of conversion of, a potential irritant to something that is less of an irritant. In use, the catalytic material may act to convert, or increase the rate of conversion of, formic acid to methanol, for example. In other embodiments, the catalytic material may act to convert, or increase the rate of conversion of, other chemicals, such as acetylene to ethane by hydrogenation, or ammonia to nitrogen and hydrogen. The catalytic material may additionally or alternatively act to react, or increase the rate of reaction of, carbon monoxide and water vapor to form carbon dioxide and hydrogen (the water-gas shift reaction, or WGSR).

In some embodiments, a first portion of the heating element 130 may be more susceptible to eddy currents being induced therein by penetration with the varying magnetic field than a second portion of the heating element 130. For example, a first portion of the heating element 130 may have the higher susceptibility as a result of the first portion of the heating element 130 being made of a first material, the second portion of the heating element 130 being made of a different second material, and the first material being of a higher susceptibility than the second material. For example, one of the first and second portions may be made of iron, and the other of the first and second portions may be made of graphite. Alternatively or additionally, the first portion of the heating element 130 may have the higher susceptibility as a result of the first portion of the heating element 130 having a different thickness and/or material density to the second portion of the heating element 130.

The higher susceptibility portion may be located closer to an intended mouth end of the apparatus 100, or the lower susceptibility portion may be located closer to the intended mouth end of the apparatus 100. In the latter scenario, the lower susceptibility portion may heat smokable material in an article located in the heating zone 113 to a lesser degree than the higher susceptibility portion, and thus the lesser heated smokable material could act as a filter, to reduce the temperature of created vapor or make the vapor created in the article mild during heating of the smokable material.

The first and second portions of the heating element 130 may be located adjacent each other in the longitudinal direction of the heating element 130, or may be disposed adjacent each other in a direction perpendicular to the longitudinal direction of the heating element 130, for example.

Such varying susceptibility of the heating element 130 to eddy currents being induced therein may help achieve progressive heating of smokable material in an article inserted in the heating zone 113, and thereby progressive generation of vapor. For example, the higher susceptibility portion may be able to heat a first region of the smokable material relatively quickly to initialize volatilization of at least one component of the smokable material and formation of a vapor in the first region of the smokable material. The lower susceptibility portion may be able to heat a second region of the smokable material relatively slowly to initialize volatilization of at least one component of the smokable material and formation of a vapor in the second region of the smokable material. Accordingly, a vapor is able to be formed relatively rapidly for inhalation by a user, and vapor can continue to be formed thereafter for subsequent inhalation by the user even after the first region of the smokable material may have ceased generating vapor. The first region of the smokable material may cease generating the vapor when it becomes exhausted of volatilizable components of the smokable material.

In other embodiments, all of the heating element 130 may be equally, or substantially equally, susceptible to eddy currents being induced therein by penetration with a varying magnetic field. In some embodiments, the heating element 130 may not be susceptible to such eddy currents. In such embodiments, the heating material may be a magnetic material that is non-electrically-conductive, and thus may be heatable by the magnetic hysteresis process discussed above.

In some embodiments, the heating element 130 may be arranged to change shape when heated. That is, the shape of the heating element 130 may be temperature-sensitive. For example, the heating element 130 may be arranged to bend when heated and/or may be arranged to expand when heated. The change in shape could comprise a deflection away from a longitudinal axis of the heating zone 113. In some embodiments, the heating element 130 may be spiral-shaped or helical, such as around a longitudinal axis of the heating zone 113, and heating of the heating element 130 may cause the spiral-shaped or helical heating element 130 to partially unwind, thereby to increase a diameter or width of the heating element 130. Such a change in shape of the heating element 130 may help to provide or increase contact between the heating element 130 and an article located in the heating zone 113. This may help to improve the conduction of heat from the heating element 130 to the article and smokable material located therein.

The heating element 130 may comprise two portions that are attached to each other and have respective different coefficients of expansion, which thereby possess different capacities to expand as they are heated. The two portions may be elongate and/or parallel to the longitudinal axis of the heating zone 113, for example. When heated, the heating element 130 may bend or buckle due to the different expansion properties of the two portions. In this way, a change in temperature is converted into physical displacement or deformation. The degree of shape-changing of the heating element 130 may be related to temperature such that at a higher temperature, the heating element 130 demonstrates a greater degree of displacement or deformation. The degree of displacement or deformation of the heating element 130 may be proportional to a magnitude of a change in temperature of the heating element 130.

Suitable heating elements 130 for use in the apparatus 100 may vary in terms of, for example, thickness and cross-sectional shape of the portions, the material compositions of the portions, the arrangement by which the portions are bonded together, etc., and these variables may affect the properties of the heating element 130, such as the capacity of the heating element 130 to bend, the thermal conductivity, etc. In some embodiments, the two portions may be two different plastic polymers having respective different coefficients of expansion. In other embodiments, the two portions may be two different metals having respective different coefficients of expansion. Thus, the heating element 130 may comprise a bimetallic strip. An example bimetallic strip may comprise a steel portion and a copper portion. In other embodiments, other combinations of materials may be used, such as manganese and copper, or brass and steel.

The magnetic field generator 120 of this embodiment comprises an electrical power source 121, the coil 122, a device 123 for passing a varying electrical current, such as an alternating current, through the coil 122, a controller 124, and a user interface 125 for user- operation of the controller 124.

In this embodiment, the electrical power source 121 is a rechargeable battery. In other embodiments, the electrical power source 121 may be other than a rechargeable battery, such as a non-rechargeable battery, a capacitor or a connection to a mains electricity supply.

The coil 122 may take any suitable form. In this embodiment, the coil 122 is a helical coil of electrically-conductive material, such as copper. In some embodiments, the magnetic field generator 120 may comprise a magnetically permeable core around which the coil 122 is wound. Such a magnetically permeable core concentrates the magnetic flux produced by the coil 122 in use and makes a more powerful magnetic field. The magnetically permeable core may be made of iron, for example. In some embodiments, the magnetically permeable core may extend only partially along the length of the coil 122, so as to concentrate the magnetic flux only in certain regions.

In this embodiment, the coil 122 is a circular helix. That is, the coil 122 has a substantially constant radius along its length. In other embodiments, the radius of the coil 122 may vary along its length. For example, in some embodiments, the coil 122 may comprise a conic helix or an elliptical helix. In this embodiment, the coil 122 has a substantially constant pitch along its length. That is, a width measured parallel to the longitudinal axis of the coil 122 of a gap between any two adjacent turns of the coil 122 is substantially the same as a width of a gap between any other two adjacent turns of the coil 122. In other embodiments, this may not be true. The provision of a varying pitch may enable the strength of a varying magnetic field produced by the coil 122 to be different at different portions of the coil 122, which may help provide progressive heating of the heating element 130 and heating zone 113, and thus any article located in the heating zone 113, in a manner similar to that described above.

In this embodiment, the coil 122 is in a fixed position relative to the heating element 130 and the heating zone 113. In this embodiment, the coil 122 encircles the heating element 130 and the heating zone 113. In this embodiment, the coil 122 extends along a longitudinal axis that is substantially aligned with the longitudinal axis A-A of the heating zone 113. In this embodiment, the aligned axes are coincident. In a variation to this embodiment, the aligned axes may be parallel to each other. However, in other embodiments, the axes may be oblique to each other. Moreover, in this embodiment, the coil 122 extends along a longitudinal axis that is substantially coincident with the longitudinal axis of the heating element 130. This can help to provide more uniform heating of the heating element 130 in use, and can also aid manufacturability of the apparatus 100. In other embodiments, the longitudinal axes of the coil 122 and the heating element 130 may be aligned with each other by being parallel to each other, or may be oblique to each other.

An impedance of the coil 122 of the magnetic field generator 120 of this embodiment is equal, or substantially equal, to an impedance of the heating element 130. If the impedance of the heating element 130 were instead lower than the impedance of the coil 122 of the magnetic field generator 120, then the voltage generated across the heating element 130 in use may be lower than the voltage that may be generated across the heating element 130 when the impedances are matched. Alternatively, if the impedance of the heating element 130 were instead higher than the impedance of the coil 122 of the magnetic field generator 120, then the electrical current generated in the heating element 130 in use may be lower than the current that may be generated in the heating element 130 when the impedances are matched. Matching the impedances may help to balance the voltage and current to maximize the heating power generated at the heating element 130 when heated in use. In some other embodiments, the impedances may not be matched.

In this embodiment, the device 123 for passing a varying current through the coil 122 is electrically connected between the electrical power source 121 and the coil 122. In this embodiment, the controller 124 also is electrically connected to the electrical power source 121, and is communicatively connected to the device 123. The controller 124 is for causing and controlling heating of the heating element 130. More specifically, in this embodiment, the controller 124 is for controlling the device 123, so as to control the supply of electrical power from the electrical power source 121 to the coil 122. In this embodiment, the controller 124 comprises an integrated circuit (IC), such as an IC on a printed circuit board (PCB). In other embodiments, the controller 124 may take a different form. In some embodiments, the apparatus may have a single electrical or electronic component comprising the device 123 and the controller 124. The controller 124 is operated in this embodiment by user-operation of the user interface 125. The user interface 125 is located at the exterior of the apparatus 100. The user interface 125 may comprise a push-button, a toggle switch, a dial, a touch screen, or the like.

In this embodiment, operation of the user interface 125 by a user causes the controller 124 to cause the device 123 to cause an alternating electrical current to pass through the coil 122, so as to cause the coil 122 to generate an alternating magnetic field. The coil 122 and the heating element 130 are suitably relatively positioned so that the alternating magnetic field produced by the coil 122 penetrates the heating material of the heating element 130. When the heating material of the heating element 130 is an electrically-conductive material, this may cause the generation of one or more eddy currents in the heating material. The flow of eddy currents in the heating material against the electrical resistance of the heating material causes the heating material to be heated by Joule heating. As mentioned above, when the heating material is made of a magnetic material, the orientation of magnetic dipoles in the heating material changes with the changing applied magnetic field, which causes heat to be generated in the heating material.

The apparatus 100 of this embodiment comprises a temperature sensor 126 for sensing a temperature of the heating zone 113. The temperature sensor 126 is communicatively connected to the controller 124, so that the controller 124 is able to monitor the temperature of the heating zone 113. In some embodiments, the temperature sensor 126 may be arranged to take an optical temperature measurement of the heating zone 113 or of an article located in the heating zone 113. In some embodiments, the article to be located in the heating zone 113 may comprise a temperature detector, such as a resistance temperature detector (RTD), for detecting a temperature of the article. The article may further comprise one or more terminals connected, such as electrically-connected, to the temperature detector. The terminal(s) may be for making connection, such as electrical connection, with a temperature monitor (not shown) of the apparatus 100 when the article is in the heating zone 113. The controller 124 may comprise the temperature monitor. The temperature monitor of the apparatus 100 may thus be able to determine a temperature of the article during use of the article with the apparatus 100.

On the basis of one or more signals received from the temperature sensor 126 (and/or temperature detector, when provided), the controller 124 may cause the device 123 to adjust a characteristic of the varying or alternating electrical current passed through the coil 122 as necessary, in order to ensure that the temperature of the heating zone 113 remains within a predetermined temperature range. The characteristic may be, for example, amplitude or frequency. Within the predetermined temperature range, in use smokable material within an article located in the heating zone 113 is heated sufficiently to volatilize at least one component of the smokable material without combusting the smokable material. Accordingly, the controller 124, and the apparatus 100 as a whole, is arranged to heat the smokable material to volatilize the at least one component of the smokable material without combusting the smokable material. In some embodiments, the temperature range is about 50° C. to about 250° C., such as between about 50° C. and about 150° C., between about 50° C. and about 120° C., between about 50° C. and about 100° C., between about 50° C. and about 80° C., or between about 60° C. and about 70° C. In some embodiments, the temperature range is between about 170° C. and about 220° C. In other embodiments, the temperature range may be other than these ranges.

In some embodiments, the apparatus 100 may comprises a mouthpiece (not shown). The mouthpiece may be releasably engageable with the rest of the apparatus 100 so as to connect the mouthpiece to the rest of the apparatus 100. In other embodiments, the mouthpiece and the rest of the apparatus 100 may be permanently connected, such as through a hinge or flexible member.

The mouthpiece may be locatable relative to the body 110 so as to cover the opening 114 into the heating zone 113. When the mouthpiece is so located relative to the body 110, a channel through the mouthpiece may be in fluid communication with the heating zone 113. In use, the channel acts as a passageway for permitting volatilized material to pass from the heating zone 113 to an exterior of the apparatus 100.

The mouthpiece, when provided, may comprise or be impregnated with a flavorant. The flavorant may be arranged so as to be picked up by heated vapor as the vapor passes through the passageway of the mouthpiece in use.

As the heating zone 113, and thus any article therein, is being heated, a user may be able to inhale the volatilized component(s) of the smokable material by drawing the volatilized component(s) through a mouthpiece of the article (when provided) or through a mouthpiece of the apparatus 100 (when provided). Air may enter the article via a gap between the article and the body 110, or in some embodiments the apparatus 100 may define an air inlet that fluidly connects the heating zone 113 with the exterior of the apparatus 100. As the volatilized component(s) are removed from the article, air may be drawn into the heating zone 113 via the air inlet of the apparatus 100.

Some embodiments of the apparatus 100 may be arranged to provide “self-cleaning” of the heating element 130. For example, in some embodiments, the controller 124 may be arranged, such as on suitable user operation of the user interface 125, to cause the device 123 to adjust a characteristic of the varying or alternating electrical current passed through the coil 122 as necessary, in order to increase the temperature of the heating element 130 to a level at which residue or leftovers on the heating element 130 from a previously expended article may be incinerated. The characteristic may be, for example, amplitude or frequency. The temperature may be, for example, in excess of 500 degrees Celsius.

Some embodiments of the apparatus 100 may be arranged to provide haptic feedback to a user. The feedback could indicate that heating is taking place, or be triggered by a timer to indicate that greater than a predetermined proportion of the original quantity of volatilizable component(s) of the smokable material in an article in the heating zone 113 has/have been spent, or the like. The haptic feedback could be created by interaction of the coil 122 and the heating element 130 (i.e. magnetic response), by interaction of an electrically-conductive element with the coil 122, by rotating an unbalanced motor, by repeatedly applying and removing a current across a piezoelectric element, or the like. Additionally or alternatively, some embodiments of the apparatus 100 may utilize such haptics to aid the “self-cleaning” process discussed above, by vibration cleaning the heating element 130.

In some embodiments, the magnetic field generator 120 may be for generating a plurality of varying magnetic fields for penetrating different respective portions of the heating element 130. For example, the apparatus 100 may comprise more than one coil. The plurality of coils of the apparatus 100 could be operable to provide progressive heating of the heating element 130, and thus progressive heating of smokable material in an article located in the heating zone 113, so as to provide progressive generation of vapor. For example, one coil may be able to heat a first region of the heating material relatively quickly to initialize volatilization of at least one component of the smokable material and formation of a vapor in a first region of the smokable material. Another coil may be able to heat a second region of the heating material relatively slowly to initialize volatilization of at least one component of the smokable material and formation of a vapor in a second region of the smokable material. Accordingly, a vapor is able to be formed relatively rapidly for inhalation by a user, and vapor can continue to be formed thereafter for subsequent inhalation by the user even after the first region of the smokable material may have ceased generating vapor. The initially- unheated second region of smokable material could act as a filter, to reduce the temperature of created vapor or make the created vapor mild, during heating of the first region of smokable material.

In some embodiments, the apparatus 100 may comprises a first mass of thermal insulation between the coil 122 and the body 110. The first mass of thermal insulation may encircle the body 110. The first mass of thermal insulation may comprise, for example, one or more thermal insulators selected from the group consisting of: a closed-cell material, a closed-cell plastics material, an aerogel, vacuum insulation, silicone foam, and a rubber material. The thermal insulation may additionally or alternatively comprise an air gap. Such a first mass of thermal insulation may help to prevent heat loss from the heating element 130 to components of the apparatus 100 other than the heating zone 113, may help to increase heating efficiency of the heating zone 113, and/or may help to reduce the transfer of heating energy from the heating element 130 to an outer surface of the apparatus 100. This may improve the comfortableness with which a user is able to hold the apparatus 100.

In some embodiments, the apparatus 100 may comprise a second mass of thermal insulation that encircles the coil 122. The second mass of thermal insulation may comprise, for example, one or more materials selected from the group consisting of: aerogel, vacuum insulation, wadding, fleece, non-woven material, non-woven fleece, woven material, knitted material, nylon, foam, polystyrene, polyester, polyester filament, polypropylene, a blend of polyester and polypropylene, cellulose acetate, paper or card, and corrugated material such as corrugated paper or card. In some embodiments, the second mass of thermal insulation may comprise one or more of the materials discussed above for the first mass of thermal insulation. The thermal insulation may additionally or alternatively comprise an air gap. Such a second mass of thermal insulation may help to reduce the transfer of heating energy from the heating element 130 to an outer surface of the apparatus 100, and may additionally or alternatively help to increase heating efficiency of the heating zone 113.

In some embodiments, one or both of the first and second masses of thermal insulation may be omitted. In some embodiments, the coil 122 may be embedded in a body of thermal insulation. Such a body of thermal insulation may abut or envelop the body 110. Such a body of thermal insulation may comprise, for example, one or more thermal insulators selected from the group consisting of: a closed-cell material, a closed-cell plastics material, an aerogel, vacuum insulation, silicone foam, and a rubber material. In addition to the thermal benefits discussed above, such a body of thermal insulation may help to increase the robustness of the apparatus 100, such as by helping to maintain the relative positioning of the coil 122 and the body 110.

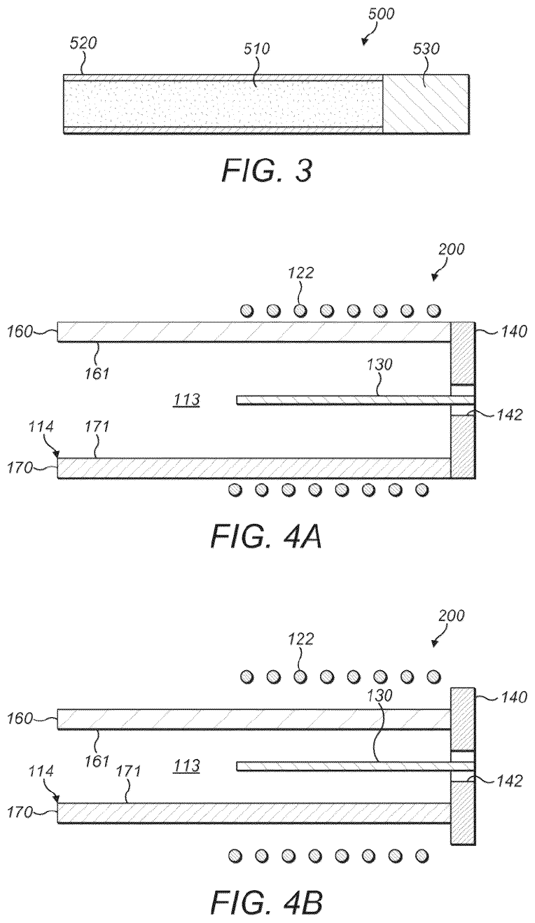

Referring to FIG. 3, there is shown a schematic cross-sectional view of an article for use with apparatus for heating smokable material to volatilize at least one component of the smokable material, such as one of the apparatuses 100, 200, 300 described herein. Broadly speaking, the article 500 comprises a mass of smokable material 510 and a wiper 530 connected to the mass of smokable material 510. The article 500 is arranged so that a heating element for heating the smokable material 510, such as the heating element 130 of the apparatus 100, is insertable into the mass of smokable material 510 while making contact with the wiper 530.

In this embodiment, each of the article 500 and the mass of smokable material 510 is elongate, and the wiper 530 is located at a longitudinal end of the mass of smokable material 510. In other embodiments, the article 500 and/or the mass of smokable material 510 may have a different form factor.

In this embodiment, the article 500 comprises a cover 520 around the smokable material 510 for maintaining the structural integrity of the smokable material 510. The cover 520 may be made of any suitable material, such as paper, card, plastic film, foil, or the like. The wiper 530 may be attached to the cover 520, such as by a band of material (not shown) extending around portions of the cover 520 and wiper 530 at the join between the cover 520 and wiper 530, thereby to connect the wiper 530 to the smokable material 510.

The wiper 530 may comprise any material, or have any form, suitable for wiping, or for abrading, or for scraping residue or leftovers from the heating element 130, as the heating element 130 is inserted into the smokable material 510 while making contact with the wiper 530 or as the heating element 130 is withdrawn from the smokable material 510 while making contact with the wiper 530. The wiper 530 thus may help to clean the heating element 130 of the apparatus 100 before or after use of the article 500 with the apparatus 100.

In some embodiments, the wiper 530 may comprise a scraper. In this embodiment, the wiper 530 comprises an abrasive pad. In this embodiment, the abrasive pad is formed of tangled metal filaments, such as metal wool, e.g. steel wool, brass wool, or the like. In other embodiments, the abrasive pad may comprise one or more of: a foam material, metal filaments, metal filaments of plural relative orientations, tangled metal filaments, and metal bristles, or the like. In some embodiments, the wiper 530 may comprise a blade, such as a metal or plastic blade. The blade may be oriented perpendicularly or obliquely to an insertion direction of the heating element 130, such as perpendicularly or obliquely to a longitudinal axis of the article 500. In some embodiments, the wiper 530 may comprise an uneven surface for rubbing or scraping the heating element 130 during relative movement of the wiper 530 and the heating element 130. For example, the wiper 530 may comprise a corrugated member or a member having a plurality of lumps or protrusions extending therefrom. The lumps or protrusions may protrude from the member in a direction having at least a component that is perpendicular or oblique to an insertion direction of the heating element 130, such as perpendicular or oblique to a longitudinal axis of the article 500.

In some embodiments, the article 500 may have a cavity formed therein for receiving the heating element 130 in use. In some embodiments, the smokable material may define at least a portion of the cavity. In some embodiments, at least a portion of the cavity may be defined by a thermally-conductive pocket, sleeve or liner. The pocket, sleeve or liner may be made, for example, from a foil, such as aluminum. In some embodiments, the wiper 530 may define at least a portion of the cavity so as to be able to contact the heating element 130 as the heating element moves within the cavity in use. For example, the wiper 530 may define a mouth of the cavity.

Referring to FIG. 4a, there is shown a schematic cross-sectional view of an example of another apparatus for heating smokable material to volatilize at least one component of the smokable material, according to an embodiment of the disclosure. The apparatus 200 of this embodiment is identical to the apparatus 100 of FIGS. 1 and 2, except for the features that define the heating zone 113, and the form of the heating element 130. Therefore, in the interests of conciseness, repeated discussion of the various features of the apparatus 200 will be omitted and the Figure shows only those components of the apparatus 200 necessary for understanding the technical features and advantages discussed below. Any of the above- described possible variations to the apparatus 100 of FIGS. 1 and 2 may be made to the apparatus 200 of FIG. 4a to form separate respective embodiments.

In this embodiment, the heating element 130 comprises the heating member that consists entirely, or substantially entirely, of the heating material, and the coating 136 on the heating member is omitted. However, in other embodiments, the heating element 130 may have the same construction as the heating element 130 of the apparatus 100 of FIGS. 1 and 2 or any of the above-described variations thereof.

In this embodiment, the body 110 defining the heating zone 113 is omitted, and the heating zone 113 is instead between first and second members 160, 170 that are movable towards each other to compress the heating zone 113. In FIG. 4a, the first and second members 160, 170 are shown in a first state in which the first and second members 160, 170 are spaced apart by a first distance. The first and second members 160, 170 are relatively movable to reduce the distance between the first and second members 160, 170 until the first and second members 160, 170 reach a second state, as shown in FIG. 4b, at which the first and second members 160, 170 are spaced apart by a second distance that is less than the first distance. In this embodiment, each of the first and second members 160, 170 is movable relative to the heating element 130. In other embodiments, only one of the first and second members 160, 170 may be movable relative to the heating element 130. In this embodiment, each of the first and second members 160, 170 is movable relative to the coil 122. In other embodiments, only one or none of the first and second members 160, 170 may be movable relative to the coil 122. That is, the coil 122 may move or deform with the relative movement of the first and second members 160, 170.

In this embodiment, the first and second members 160, 170 are free of any heating material that is heatable by penetration with a varying magnetic field. Thus, when a varying magnetic field is generated by the magnetic field generator, more energy of the varying magnetic field is available to cause heating of the heating element 130. However, in other embodiments, one or both of the first and second members 160, 170 may comprise heating material that is heatable by penetration with a varying magnetic field.

In use, an article comprising smokable material may be located in the heating zone 113 when the first and second members 160, 170 are at the relative position shown in FIG. 4a. The first and second members 160, 170 may then be relatively moved towards the state shown in FIG. 4b to compress the heating zone 113 and the article therein. That is, the article may be squeezed by one or both of respective inner surfaces 161, 171 of the first and second members 160, 170. Such compression of the article may cause compression of the smokable material therein, which may increase the thermal conductivity of the smokable material. This, in turn, may help increase the ability of heat from the heating element 130 to penetrate the smokable material, which may enable better or more complete volatilization of at least one component of the smokable material. When the volatilizable component(s) of the smokable material have been spent, the first and second members 160, 170 may be relatively movable back to the state shown in FIG. 4a, to facilitate removal of the article from the heating zone 113.

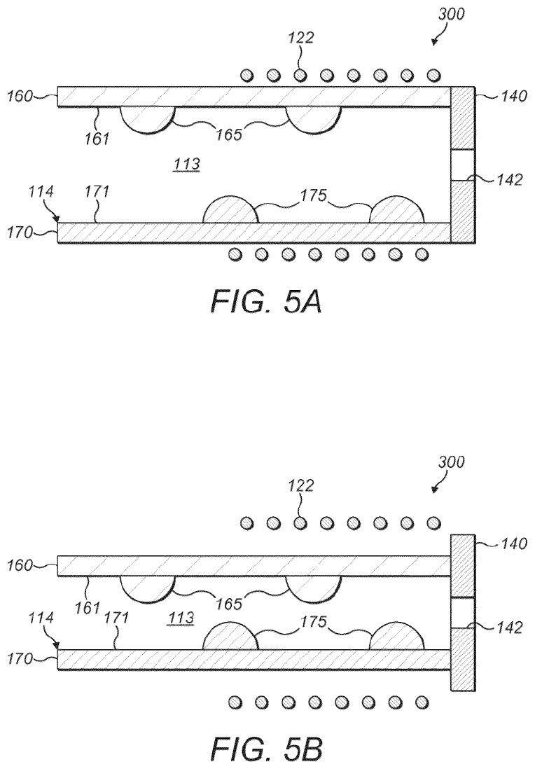

In other embodiments, the heating element 130 within the heating zone 113 may be omitted. Referring to FIG. 5a, there is shown a schematic cross-sectional view of an example of another apparatus for heating smokable material to volatilize at least one component of the smokable material, according to such an embodiment of the disclosure. The apparatus 300 of this embodiment is identical to the apparatus 200 of FIGS. 4a and 4b, except for the features discussed in the following paragraphs. Therefore, in the interests of conciseness, repeated discussion of the various features of the apparatus 200 will be omitted and the Figures show only those components of the apparatus 300 necessary for understanding the technical features and advantages discussed below. Any of the above- described possible variations to the apparatus 200 of FIGS. 4a and 4b may be made to the apparatus 300 of FIG. 5a to form separate respective embodiments.

In this embodiment, the heating element 130 discussed above is omitted, and the heating zone 113 is free of any heating material that is heatable by penetration with a varying magnetic field. This apparatus 300 is intended to be used with an article that comprises both smokable material and heating material that is heatable by penetration with a varying magnetic field. Therefore, the magnetic field generator is arranged to generate a varying magnetic field that penetrates the heating zone 113 in use, so as to cause heating of the heating material of the article.

In this embodiment, the inner surfaces 161, 171 of the first and second members 160, 170 have respective protrusions 165, 175 extending therefrom and into the heating zone 113. In this embodiment, the protrusions 165, 175 are axially staggered or offset from one another, so that as the first and second members 160, 170 relatively move towards each other to reach the state shown in FIG. 5b in which the heating zone 113 is compressed, the protrusions 165, 175 do not contact one other. Moreover, in use, when the article is located in the heating zone 113, as the first and second members 160, 170 relatively move to compress the heating zone 113, the offset protrusions 165, 175 act to apply respective offset forces to the article, thereby to deform the article into a zig-zag or squiggle shape. This may have the effect of creating a tortuous flow path through the smokable material of the article, which may create turbulence in air passing through the smokable material so as to help the air to pick up volatilized material created when the smokable material is heated. However, in other embodiments, the protrusions 165, 175 may not be offset from one other.

The apparatus 300 of FIGS. 5a and 5b is operable is a similar manner to the apparatus 200 of FIGS. 4a and 4b. Thus, an article comprising smokable material and heating material may be located in the heating zone 113 when the first and second members 160, 170 are at the relative position shown in FIG. 5a. The first and second members 160, 170 may then be relatively moved towards the state shown in FIG. 5b to compress the heating zone 113 and the article therein. This may provide one or more of the benefits discussed above. When the volatilizable component(s) of the smokable material have been spent, the first and second members 160, 170 may be relatively movable back to the state shown in FIG. 5a, to facilitate removal of the article from the heating zone 113.

In a variation to the apparatus 300 shown in FIGS. 5a and 5b, one or both of the first and second members 160, 170 may comprise heating material that is heatable by penetration with a varying magnetic field. For example, the protrusions 165, 175 of one or both of the first and second members 160, 170 may comprise such heating material. This may further increase the ability of heat from the heating material to penetrate the smokable material of an article in the heating zone 113 in use. In some embodiments, the protrusions 165, 175 may be loop-or ring-shaped.

In some embodiments that are variations of the apparatus 300 shown in FIGS. 5a and 5b, the protrusions 165, 175 of one or both of the first and second members 160, 170 may be omitted.

In some embodiments that are variations of the apparatus 300 shown in FIGS. 5a and 5b, the apparatus 300 may comprise the heating element 130 of the apparatus 200 shown in FIGS. 4a and 4b.

In some embodiments that are variations of the apparatus 200 shown in FIGS. 4a and 4b, the inner surfaces 161, 171 of the first and second members 160, 170 may have respective protrusions extending therefrom and into the heating zone 113, in the same manner as the protrusions 165, 175 of the apparatus 300 shown in FIGS. 5a and 5b. Such protrusions in the apparatus 200 of FIGS. 4a and 4b may have any of the features discussed above for the protrusions 165, 175 of the apparatus 300 shown in FIGS. 5a and 5b.

In some embodiments, the heating material of the heating element 130 may comprise discontinuities or holes therein. Such discontinuities or holes may act as thermal breaks to control the degree to which different regions of the smokable material are heated in use. Areas of the heating material with discontinuities or holes therein may be heated to a lesser extent that areas without discontinuities or holes. This may help progressive heating of the smokable material, and thus progressive generation of vapor, to be achieved.

In each of the above described embodiments, the smokable material comprises tobacco. However, in respective variations to each of these embodiments, the smokable material may consist of tobacco, may consist substantially entirely of tobacco, may comprise tobacco and smokable material other than tobacco, may comprise smokable material other than tobacco, or may be free of tobacco. In some embodiments, the smokable material may comprise a vapor or an aerosol forming agent or a humectant, such as glycerol, propylene glycol, triactein, or diethylene glycol.

In some embodiments, the article discussed above is sold, supplied or otherwise provided separately from the apparatus 100, 200, 300 with which it is usable. However, in some embodiments, the apparatus 100, 200, 300 and one or more of the articles may be provided together as a system, such as a kit or an assembly, possibly with additional components, such as cleaning utensils.

Embodiments of the disclosure could be implemented in a system comprising any one of the articles discussed herein, and any one of the apparatuses discussed herein, wherein the article itself further has heating material, such as in a susceptor, for heating by penetration with the varying magnetic field generated by the magnetic field generator. Heat generated in the heating material of the article itself could be transferred to the smokable material to further heat the smokable material therein.

In order to address various issues and advance the art, the entirety of this disclosure shows by way of illustration and example various embodiments in which the claimed invention may be practiced and which provide for superior apparatus for heating smokable material to volatilize at least one component of the smokable material, superior articles for use with such apparatus, and superior systems comprising such articles and such apparatus. The advantages and features of the disclosure are of a representative sample of embodiments only, and are not exhaustive and/or exclusive. They are presented only to assist in understanding and teach the claimed and otherwise disclosed features. It is to be understood that advantages, embodiments, examples, functions, features, structures and/or other aspects of the disclosure are not to be considered limitations on the disclosure as defined by the claims or limitations on equivalents to the claims, and that other embodiments may be utilized and modifications may be made without departing from the scope and/or spirit of the disclosure. Various embodiments may suitably comprise, consist of, or consist in essence of, various combinations of the disclosed elements, components, features, parts, steps, means, etc. The disclosure may include other inventions not presently claimed, but which may be claimed in future.

1. An apparatus for heating smokable material to volatilize at least one component of the smokable material, the apparatus comprising:
a body encircling a heating zone, the heating zone comprising a cavity configured to receive at least a portion of an article that comprises the smokable material;
a magnetic field generator configured to generate a varying magnetic field; and
an elongate heating element non-removably coupled to the body that projects into the heating zone;
wherein the heating element comprises a heating material that is heatable by penetration with the varying magnetic field to thereby heat the heating zone, wherein the magnetic field generator comprises a coil and a controller configured to pass a varying electrical current through the coil, and wherein in the absence of the article inserted in the heating zone the coil is in a fixed position relative to the heating element and the heating zone.

2. The apparatus of claim 1, wherein the body is free of heating material that is heatable by penetration with the varying magnetic field.

3. The apparatus of claim 1, wherein the heating zone is elongate, and the elongate heating element extends along a longitudinal axis that is substantially coincident with a longitudinal axis of the heating zone.

4. The apparatus of claim 1, further comprising an opening defined at a first end of the heating zone and configured to receive the at least a portion of the article,
wherein the heating element projects into the heating zone from a second end of the heating zone opposite the first end, and wherein the heating element has a free end distal from the second end of the heating zone that is arranged relative to the opening so as to enter the article as the article is inserted into the heating zone.

5. The apparatus of claim 1, wherein an inner surface of the body or an outer surface of the body has a thermal emissivity of 0.1 or less.

6. The apparatus of claim 1, wherein the coil extends along a longitudinal axis that is coincident with a longitudinal axis of the heating element.

7. The apparatus of claim 1, wherein an impedance of the coil is equal to an impedance of the heating element.

8. The apparatus of claim 1, wherein the heating material comprises a metal or a metal alloy.

9. The apparatus of claim 1, wherein the heating material comprises one or more materials selected from the group consisting of: aluminum, gold, iron, nickel, cobalt, conductive carbon, graphite, plain-carbon steel, stainless steel, ferritic stainless steel, copper, and bronze.

10. The apparatus of claim 1, wherein the heating material is susceptible to eddy currents induced in the heating material when the heating material is penetrated by the varying magnetic field.

11. A portable hand-held apparatus for heating smokable material to volatilize at least one component of the smokable material, the apparatus comprising:
a rechargeable power source;
a body having a first member and a second member;
a heating zone defined between the first member and the second member, the heating zone defining a cavity and being configured to receive at least a portion of an article that comprises the smokable material; and
a magnetic field generator configured to generate a varying magnetic field to heat the heating zone during use;
wherein the first member and the second member are arranged to move towards each other to compress the heating zone, and wherein one or both of the first member or the second member comprises a heating material that is heatable by penetration with the varying magnetic field to heat the heating zone.

12. The apparatus of claim 11, wherein the magnetic field generator is configured to generate a varying magnetic field that penetrates the heating zone.

13. The apparatus of claim 11, further comprising a heating element including the heating material that is heatable by penetration with the varying magnetic field to thereby heat the heating zone.

14. A system, comprising:
an article comprising smokable material; and
an apparatus for heating smokable material to volatilize at least one component of the smokable material, the apparatus comprising:
a body encircling a heating zone, the heating zone comprising a cavity configured to receive at least a portion of the article;
a magnetic field generator configured to generate a varying magnetic field; and
an elongate heating element non-removably coupled to the body that projects into the heating zone;
wherein the heating element comprises a heating material that is heatable by penetration with the varying magnetic field to thereby heat the heating zone, wherein the magnetic field generator comprises a coil and a controller configured to pass a varying electrical current through the coil, and wherein in the absence of the article inserted in the heating zone the coil is in a fixed position relative to the heating element and the heating zone.

15. A system, comprising:
an apparatus comprising:
a body having a first member and a second member;
a heating zone defined between the first member and the second member, the heating zone defining a cavity and being configured to receive at least a portion of an article that comprises the smokable material; and
a magnetic field generator configured to generate a varying magnetic field to heat the heating zone during use;
wherein the first member and the second member are arranged to move towards each other to compress the heating zone, and wherein one or both of the first member or the second member comprises a heating material that is heatable by penetration with the varying magnetic field to heat the heating zone; and
the article comprising the smokable material.

16. An apparatus for heating smokable material to volatilize at least one component of the smokable material, the apparatus comprising:
a body encircling a heating zone, the heating zone configured to receive at least a portion of an article that comprises the smokable material;
a magnetic field generator configured to generate a varying magnetic field;
an end member attached to an end portion of the body, the end member defining an end of the heating zone; and
an elongate heating element, attached to the end member, that projects into the heating zone, wherein a portion of the heating element is located in the end member,
wherein the heating element comprises heating material that is heatable by penetration with the varying magnetic field to thereby heat the heating zone;
wherein the magnetic field generator comprises a coil and a controller configured to pass a varying electrical current through the coil, and wherein the coil is in a fixed position relative to the heating element and the heating zone.

17. An apparatus for heating smokable material to volatilize at least one component of the smokable material, the apparatus comprising:
a body encircling a heating zone, the heating zone comprising a cavity configured to receive at least a portion of an article that comprises the smokable material;
a magnetic field generator configured to generate a varying magnetic field; and
an elongate heating element non-removably attached to the body and projecting into the heating zone;
wherein the heating element comprises a heating material that is heatable by penetration with the varying magnetic field to thereby heat the heating zone, wherein the magnetic field generator comprises a coil and a controller configured to pass a varying electrical current through the coil, and wherein the coil is in a fixed position relative to the heating element and the heating zone;
wherein the heating element has a free distal end arranged to enter the article as the article is inserted into the heating zone defined in the body.
